(19) United States
(12) Patent Application Publication
(10) Pub. No.: US 2024/0163731 A1
(43) Pub. Date: May 16, 2024

(54) WLAN STEERING BASED ON BAND-USAGE HISTORY

(71) Applicant: ARRIS Enterprises LLC, Suwanee, GA (US)

(72) Inventors: Ravi Kiran Mattaparti, Cupertino, CA (US); Hemant Bhatnagar, Cupertino, CA (US); Virendra Malaviya, Cupertino, CA (US)

(73) Assignee: ARRIS Enterprises LLC, Suwanee, GA (US)

(21) Appl. No.: 18/508,335

(22) Filed: Nov. 14, 2023

Related U.S. Application Data
(60) Provisional application No. 63/425,326, filed on Nov. 15, 2022.

(51) Int. Cl. H04W 28/20; H04L 5/00

(52) U.S. Cl. CPC H04W 28/20; H04L 5/0046; H04L 5/0048

(57) ABSTRACT

An access point that provides a transition recommendation is described. During operation, the access point may associate with or establish a connection with the electronic device in a band of frequencies. Moreover, the access point may access or obtain information associated with or that indicates historical band-of-frequency usage by the electronic device. For example, the access point may receive, associated with a computer system, the information. Note the computer system may include a controller of the access point and/or a cloud-based computer system. Then, based at least in part on the information, the access point may provide the transition recommendation addressed to the electronic device, where the transition recommendation recommends that the electronic device transition from the band of frequencies to a second band of frequencies, which is different from the band of frequencies.

### CROSS REFERENCE TO RELATED APPLICATIONS

This application claims priority under 35 U.S.C. 119(e) to U.S. Provisional Application Ser. No. 63/425,326, “WLAN Steering Based on Band-Usage History,” filed on Nov. 15, 2022, by Ravi Kiran Mattaparti et al., the contents of which are herein incorporated by reference.

### FIELD

The described embodiments relate to techniques for an access point to provide steering or transition recommendations based at least in part on historical band-of-frequency usage by an electronic device.

### BACKGROUND

Many electronic devices are capable of wirelessly communicating with other electronic devices. For example, these electronic devices can include a networking subsystem that implements a network interface for: a cellular network (UMTS, LTE, SGNR, etc.), a wireless local area network or WLAN (e.g., a wireless network such as described in the Institute of Electrical and Electronics Engineers (IEEE) 802.11 standard or Bluetooth™ from the Bluetooth Special Interest Group of Kirkland, Washington), and/or another type of wireless network.

In many existing WLANs, a client (which is sometimes referred to as a ‘station’ or an ‘electronic device’) that chooses to associate with or connect to an access point in a lower band of frequencies may have poorer communication performance because of a smaller number of available channels. Notably, while the client may initially scan multiple channels in different bands of frequencies, the client may choose to associate with or connect to the access point in the 2.4 GHz band of frequencies, even though the client is capable of operating in a higher band of frequencies (such as 5 GHz, 6 GHz, etc.).

For example, the access point may transmit management frames (such as beacons or probe responses) in a lower band of frequencies using a higher transmit power than is used when transmitting management frames in a higher band of frequencies (such as because of power restrictions for some channels in the 5 GHz band of frequencies or a Low Power Indoor or LPI mode in the 6 GHz band of frequencies). However, as a consequent, the client may incorrectly conclude that the lower band of frequencies has a stronger received signal strength indication (RSSI) relative to the higher band of frequencies and, thus, may associated with or connect to the access point in the lower band of frequencies. Alternatively, or additionally, some clients preferentially choose to associate with or connect to the access point in the lower band of frequencies.

Moreover, the use of the lower band of frequencies may adversely impact the communication performance and, thus, may degrade the user experience. For example, there may be fewer channels in the lower band of frequencies and the lower band of frequencies may be more crowded or congested.

### SUMMARY

An access point that provides a transition recommendation is described. This access point includes an interface circuit that wirelessly communicates with an electronic device. During operation, the access point associates with the electronic device in a band of frequencies. Moreover, the access point accesses or obtains information associated with or that indicates historical band-of-frequency usage by the electronic device. Then, based at least in part on the information, the access point provides the transition recommendation addressed to the electronic device, where the transition recommendation recommends that the electronic device transition from the band of frequencies to a second band of frequencies, which is different from the band of frequencies.

Moreover, the accessing or obtaining of the information may be based at least in part on: a media access control (MAC) address of the electronic device; an identifier used during authentication of the electronic device; and/or a username or hostname of the electronic device (such as when the electronic device uses MAC randomization).

Furthermore, the information may be stored in memory in or associated with the access point. Alternatively, or additionally, the accessing or obtaining of the information may include receiving, associated with a computer system, the information. For example, the computer system may include: a controller of the access point; or a cloud-based computer system.

In some embodiments, the information is associated with or indicates: a type of application used by the electronic device; a capability of the electronic device (such as an ability to operate in the second band of frequencies); and/or a type of traffic associated with the electronic device.

Note that the band of frequencies may include frequencies that are lower than frequencies in the second band of frequencies.

Moreover, the transition recommendation may include a basic service set (BSS) transition management (BTM) frame.

Furthermore, after providing the transition recommendation, the access point may terminate the association with the electronic device in the band of frequencies.

Additionally, the band of frequencies may be associated with a WLAN having a service set identifier (SSID) and a basic service set identifier (BSSID), and the second band of frequencies may be associated with a second WLAN having a second SSID and a second BSSID.

Another embodiment provides the computer system.

Another embodiment provides a computer-readable storage medium for use with the access point or the computer system. This computer-readable storage medium may include program instructions that, when executed by the access point or the computer system, cause the access point or the computer system to perform at least some of the aforementioned operations or counterparts to at least some of the aforementioned operations.

Another embodiment provides a method. This method includes at least some of the operations performed by the access point or counterparts to at least some of the aforementioned operations.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of a system in accordance with an embodiment of the present disclosure.

FIG. 2 is a flow diagram illustrating an example method for providing a transition recommendation using an electronic device in FIG. 1 in accordance with an embodiment of the present disclosure.

FIG. 3 is a flow diagram illustrating an example method for providing historical band-of-frequency usage information using a computer system in FIG. 1 in accordance with an embodiment of the present disclosure.

FIG. 4 is a drawing illustrating an example of communication among electronic devices in FIG. 1 in accordance with an embodiment of the present disclosure.

FIG. 5 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

An access point that provides a transition recommendation is described. During operation, the access point may associate with or establish a connection with the electronic device in a band of frequencies. Moreover, the access point may access or obtain information associated with or that indicates historical band-of-frequency usage by the electronic device. For example, the access point may receive, associated with a computer system, the information. Note the computer system may include a controller of the access point and/or a cloud-based computer system. Then, based at least in part on the information, the access point may provide the transition recommendation addressed to the electronic device, where the transition recommendation recommends that the electronic device transition from the currently used band of frequencies to a second band of frequencies, which is different from the band of frequencies.

By recommending that the electronic device transition from the band of frequencies to the second band of frequencies, these communication techniques may help ensure that the electronic device uses a band of frequencies that matches historical needs of the electronic device. For example, when the electronic device uses a type of application associated with a large utilization, a high bandwidth and/or low latency, the performance of the electronic device may be degraded when the band of frequencies is used. However, by transitioning the electronic device to the second band of frequencies, the performance of the electronic device may be maintained or improved. Therefore, the communication techniques may help ensure that the electronic device operates at its full potential. Consequently, the communication techniques may reduce user frustration when using the electronic device, the access point and a wireless network that includes the access point and, thus, may provide an improved user experience.

In the discussion that follows, electronic devices or components in a system communicate packets in accordance with a wireless communication protocol, such as: a wireless communication protocol that is compatible with an IEEE 802.11 standard (which is sometimes referred to as WiFi®, from the Wi-Fi Alliance of Austin, Texas), Bluetooth, a cellular-telephone network or data network communication protocol (such as a third generation or 3G communication protocol, a fourth generation or 4G communication protocol, e.g., Long Term Evolution or LTE (from the 3rd Generation Partnership Project of Sophia Antipolis, Valbonne, France), LTE Advanced or LTE-A, a fifth generation or 5G or SGNR communication protocol, or other present or future developed advanced cellular communication protocol), and/or another type of wireless interface (such as another wireless-local-area-network interface). For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies. Moreover, an access point, a radio node, a base station, or a switch in the wireless network may communicate with a local or remotely located computer (such as a controller) using a wired communication protocol, such as a wired communication protocol that is compatible with an IEEE 802.3 standard (which is sometimes referred to as ‘Ethernet’), e.g., an Ethernet II standard. However, a wide variety of communication protocols may be used in the system, including wired and/or wireless communication. In the discussion that follows, Wi-Fi, LTE or 5G and Ethernet are used as illustrative examples.

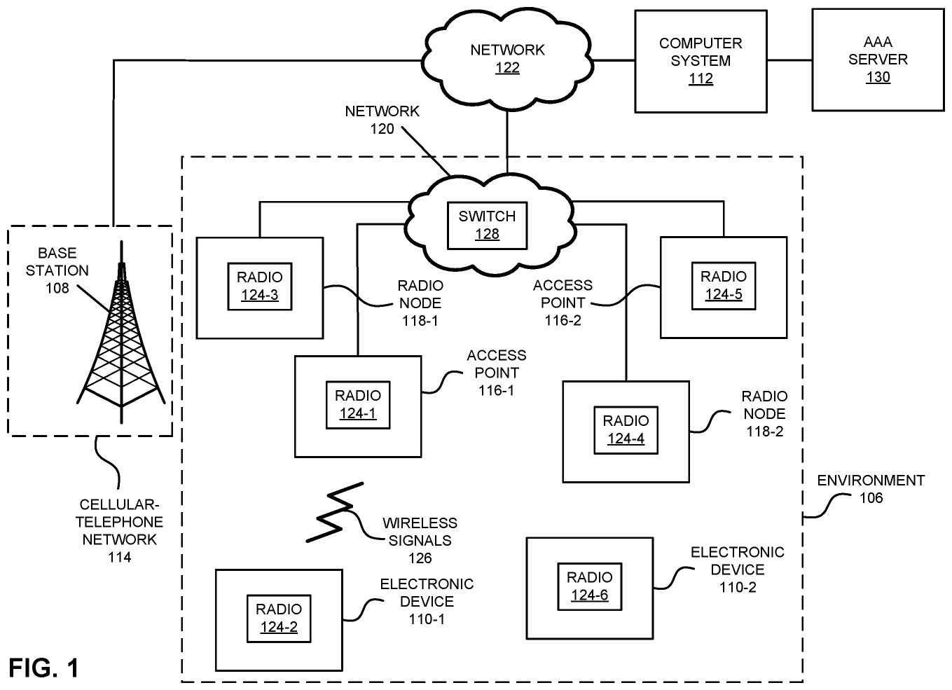

We now describe some embodiments of the communication techniques. FIG. 1 presents a block diagram illustrating an example of communication in an environment 106 with one or more electronic devices 110 (such as cellular telephones, portable electronic devices, stations or clients, another type of electronic device, etc.) via a cellular-telephone network 114 (which may include a base station 108), one or more access points 116 (which may communicate using Wi-Fi) in a WLAN and/or one or more radio nodes 118 (which may communicate using LTE) in a small-scale network (such as a small cell). For example, the one or more radio nodes 118 may include: an Evolved Node B (eNodeB), a Universal Mobile Telecommunications System (UMTS) NodeB and radio network controller (RNC), a New Radio (NR) gNB or gNodeB (which communicates with a network with a cellular-telephone communication protocol that is other than LTE), etc. In the discussion that follows, an access point, a radio node or a base station are sometimes referred to generically as a ‘communication device.’ Moreover, as noted previously, one or more base stations (such as base station 108), access points 116, and/or radio nodes 118 may be included in one or more wireless networks, such as: a WLAN, a small cell, and/or a cellular-telephone network. In some embodiments, access points 116 may include a physical access point and/or a virtual access point that is implemented in software in an environment of an electronic device or a computer.

Note that access points 116 and/or radio nodes 118 may communicate with each other and/or computer system 112 (which may include one or more computers, and may be a local or cloud-based controller that manages and/or configures access points 116, radio nodes 118 and/or switch 128, or a cloud-based computer system that provides cloud-based storage and/or analytical services) using a wired communication protocol (such as Ethernet) via network 120 and/or 122. Note that networks 120 and 122 may be the same or different networks. For example, networks 120 and/or 122 may an LAN, an intra-net, or the Internet. In some embodiments, network 120 may include one or more routers and/or switches (such as switch 128).

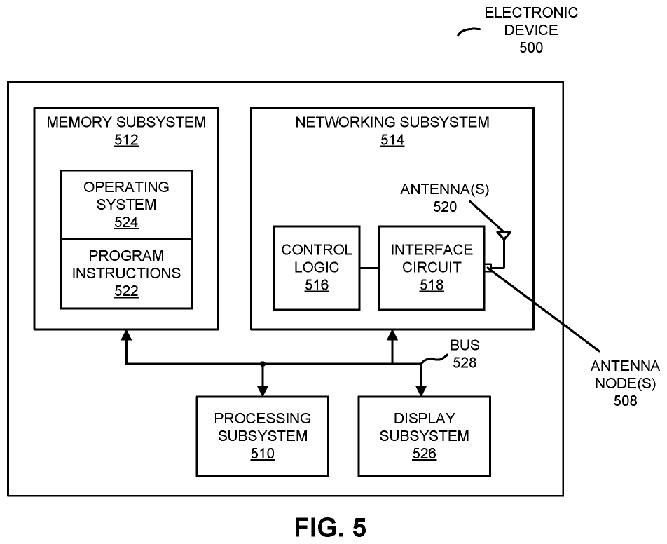

As described further below with reference to FIG. 5, electronic devices 110, computer system 112, access points 116, radio nodes 118 and switch 128 may include subsystems, such as a networking subsystem, a memory subsystem, and a processor subsystem. In addition, electronic devices 110, access points 116 and radio nodes 118 may include radios 124 in the networking subsystems. More generally, electronic devices 110, access points 116 and radio nodes 118 can include (or can be included within) any electronic devices with the networking subsystems that enable electronic devices 110, access points 116 and radio nodes 118 to wirelessly communicate with one or more other electronic devices. This wireless communication can comprise transmitting access on wireless channels to enable electronic devices to make initial contact with or detect each other, followed by exchanging subsequent data/management frames (such as connection requests and responses) to establish a connection, configure security options, transmit and receive frames or packets via the connection, etc.

During the communication in FIG. 1, access points 116 and/or radio nodes 118 and electronic devices 110 may wired or wirelessly communicate while: transmitting access requests and receiving access responses on wireless channels, detecting one another by scanning wireless channels, establishing connections (for example, by transmitting connection requests and receiving connection responses), and/or transmitting and receiving frames or packets (which may include information as payloads).

As can be seen in FIG. 1, wireless signals 126 (represented by a jagged line) may be transmitted by radios 124 in, e.g., access points 116 and/or radio nodes 118 and electronic devices 110. For example, radio 124-1 in access point 116-1 may transmit information (such as one or more packets or frames) using wireless signals 126. These wireless signals are received by radios 124 in one or more other electronic devices (such as radio 124-2 in electronic device 110-1). This may allow access point 116-1 to communicate information to other access points 116 and/or electronic device 110-1. Note that wireless signals 126 may convey one or more packets or frames.

In the described embodiments, processing a packet or a frame in access points 116 and/or radio nodes 118 and electronic devices 110 may include: receiving the wireless signals with the packet or the frame; decoding/extracting the packet or the frame from the received wireless signals to acquire the packet or the frame; and processing the packet or the frame to determine information contained in the payload of the packet or the frame.

Note that the wireless communication in FIG. 1 may be characterized by a variety of performance metrics, such as: a data rate for successful communication (which is sometimes referred to as ‘throughput’), an error rate (such as a retry or resend rate), a mean-square error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). While instances of radios 124 are shown in components in FIG. 1, one or more of these instances may be different from the other instances of radios 124.

In some embodiments, wireless communication between components in FIG. 1 uses one or more bands of frequencies, such as: 900 MHz, 2.4 GHz, 5 GHz, 6 GHz, 7 GHz, 60 GHz, the Citizens Broadband Radio Spectrum or CBRS (e.g., a frequency band near 3.5 GHz), and/or a band of frequencies used by LTE or another cellular-telephone communication protocol or a data communication protocol. Note that the communication between electronic devices may use multi-user transmission (such as orthogonal frequency division multiple access or OFDMA) and/or multiple input, multiple output (MIMO).

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

As discussed previously, an electronic device (such as electronic device 110-1) that is capable of operating in a higher band of frequencies (such as the 5 GHz or 6 GHz band of frequencies) may associated with an access point (such as access point 116-1) in a lower band of frequencies (such as the 2.4 GHz band of frequencies), which may adversely impact the communication performance of a link or connection between electronic device 110-1 and access point 116-1.

In order to address this problem, access point 116-1 may perform the communication techniques. Notably, electronic device 110-1 may associate with or establish a connection with access point 116-1 in a band of frequencies. Moreover, access point 116-1 may access or obtain information associated with or that indicates historical band-of-frequency usage by electronic device 110-1. For example, access point 116-1 may have previously received the information (such as before the current association with electronic device 110-1) from computer system 112 (such as a controller of access point 116-1). In some embodiments, computer system 112 may have aggregated or collected the information from one or more of access points 116, and then may have disseminated or provided the information to access points 116. Note that computer system 112 may periodically provide the information (such as each hour) and/or as needed (such as when there is a change in the information). Alternatively, or additionally, access point 116-1 may store the information in memory in or associated with access point 116-1, and access point 116-1 may access or obtain the information from the memory. Furthermore, the accessing or obtaining of the information may be based at least in part on: a MAC address of electronic device 110-1; an identifier used during authentication of electronic device 110-1 (such as during authentication by authentication, authorization and accounting or AAA server 130); and/or a username or hostname of electronic device 110-1 (such as when electronic device 110-1 uses MAC randomization).

Then, based at least in part on the information, access point 116-1 may determine that electronic device 110-1 will have better performance and/or will better meet its needs (as indicated by the historical band-of-frequency usage) by using a second band of frequencies, which is different from the band of frequencies. For example, electronic device 110-1 may have associated with access point 116-1 in the 2.4 GHz band of frequencies. However, historically, electronic device 116-1 may have associated with or had a connection with a wireless network in the 5 GHz band of frequencies or the 6 GHz band of frequencies. Therefore, access point 116-1 may conclude that electronic device 116-1 will have better performance in the 5 GHz band of frequencies or the 6 GHz band of frequencies.

Next, access point 116-1 may provide (e.g., based at least in part on the determination) a transition recommendation addressed to electronic device 110-1, where the transition recommendation recommends that electronic device 110-1 transition from the band of frequencies to the second band of frequencies. For example, the transition recommendation may include a BSS BTM frame. Additionally, after providing the transition recommendation, access point 116-1 may terminate the association with or the connection with electronic device 110-1 in the band of frequencies.

In some embodiments, the information is associated with or indicates: a type of application used by electronic device 110-1; a capability of electronic device 110-1 (such as an ability to operate in the second band of frequencies); and/or a type of traffic associated with electronic device 110-1 (such as video, streaming or voice traffic).

Note that the band of frequencies may be associated with a WLAN having an SSID and a BSSID, and the second band of frequencies may be associated with a second WLAN having a second SSID and a second BSSID.

In these ways, access points that use the communication techniques may ensure that electronic device 110-1 uses the correct band of frequencies. Notably, by providing a transition recommendation, the communication techniques may help ensure that electronic device 110-1 uses a band of frequencies in the WLAN that matches the needs of electronic device 110-1 (as indicated by the historical band-of-frequency usage of electronic device 110-1). This may improve the communication performance of electronic device 110-1, the WLANs and/or a wireless network that includes the WLANs. Consequently, the communication techniques may reduce user frustration when using electronic device 110-1, access point 116-1 and the wireless network and, thus, may provide an improved user experience.

In the described embodiments, processing a frame or a packet in a given one of the one or more access points 116 or a given one of the one or more electronic devices 110 may include: receiving wireless signals 126 with the frame or packet; decoding/extracting the frame or packet from the received wireless signals 126 to acquire the frame or packet; and processing the frame or packet to determine information contained in the frame or packet.

Although we describe the network environment shown in FIG. 1 as an example, in alternative embodiments, different numbers or types of electronic devices or components may be present. For example, some embodiments comprise more or fewer electronic devices or components. Therefore, in some embodiments there may be fewer or additional instances of at least some of the one or more access points 116, the one or more electronic devices 110 and/or computer system 112. As another example, in another embodiment, different electronic devices are transmitting and/or receiving frames or packets.

While the preceding discussion illustrated the communication techniques with computer system 112 providing the information to access point 116-1, in other embodiments access point 116-1 may directly obtain the information from one or more of access points 116-1 without the assistance of computer system 112. Thus, in some embodiments, at least some operations in the communication techniques may be performed in a distributed manner. Furthermore, in some embodiments, the information is not previously provided to access point 116-1. Instead, access point 116-1 may request the information from computer system 112 after associating with electronic device 110-1 (e.g., in real time). Additionally, while the preceding discussion illustrated the communication techniques with a transition recommendation from the band of frequencies with access point 116-1 to the second band of frequencies with access point 116-1, in other embodiments the transition recommendation may be from the band of frequencies with access point 116-1 to the second band of frequencies with another access point (such as access point 116-2).

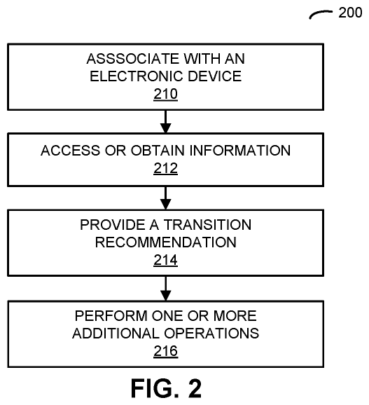

We now describe embodiments of the method. FIG. 2 presents an example of a flow diagram illustrating an example method 200 for providing a transition recommendation. Moreover, method 200 may be performed by an access point, such as one of the one or more access points 116 in FIG. 1, e.g., access point 116-1.

During operation, the access point may associate with an electronic device (operation 210) in a band of frequencies.

Moreover, the access point may access or obtain information (operation 212) associated with or that indicates historical band-of-frequency usage by the electronic device. Note that the accessing or obtaining of the information (operation 212) may be based at least in part on: a MAC address of the electronic device; an identifier used during authentication of the electronic device; and/or a username or hostname of the electronic device (such as when the electronic device uses MAC randomization). Furthermore, the information may be stored in memory in or associated with the access point. Alternatively, or additionally, the accessing or obtaining of the information may include receiving, associated with a computer system, the information. For example, the computer system may include: a controller of the access point; or a cloud-based computer system. In some embodiments, the information is associated with or indicates: a type of application used by the electronic device; a capability of the electronic device (such as an ability to operate in the second band of frequencies); and/or a type of traffic associated with the electronic device.

Then, based at least in part on the information, the access point may provide the transition recommendation (operation 214) addressed to the electronic device, where the transition recommendation recommends that the electronic device transition from the band of frequencies to a second band of frequencies, which is different from the band of frequencies. Note that the band of frequencies may include frequencies that are lower than frequencies in the second band of frequencies. Moreover, the transition recommendation may include a BSS BTM frame. Furthermore, the band of frequencies may be associated with a WLAN having an SSID and a BSSID, and the second band of frequencies may be associated with a second WLAN having a second SSID and a second BSSID.

In some embodiments, the access point optionally performs one or more additional operations (operation 216). For example, after providing the transition recommendation (operation 214), the access point may terminate the association with the electronic device in the band of frequencies.

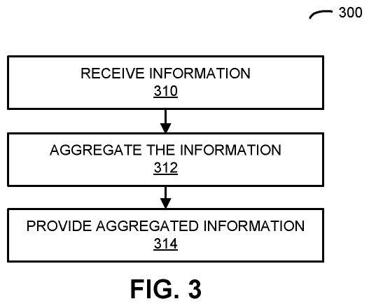

FIG. 3 presents an example of a flow diagram illustrating an example method 300 for providing historical band-of-frequency usage information. Moreover, method 300 may be performed by a computer system, such as computer system 112 in FIG. 1.

During operation, the computer system may receive, associated with one or more access points in a wireless network, information (operation 310) associated with or that indicates historical band-of-frequency usage by an electronic device.

Then, the computer system may collect or aggregate the information (operation 312) in a data structure that includes previous information about historical band-of-frequency usage by the electronic device (and possibly one or more other electronic devices).

Next, the computer system may provide, addressed to an access point in the wireless network, the aggregated information (operation 314). For example, the computer system may, periodically or as needed, provide the aggregated information or an update based at least in part on the aggregated information.

In some embodiments of methods 200 (FIG. 2) and/or 300, there may be additional or fewer operations. Moreover, there may be different operations. Furthermore, the order of the operations may be changed, and/or two or more operations may be combined into a single operation.

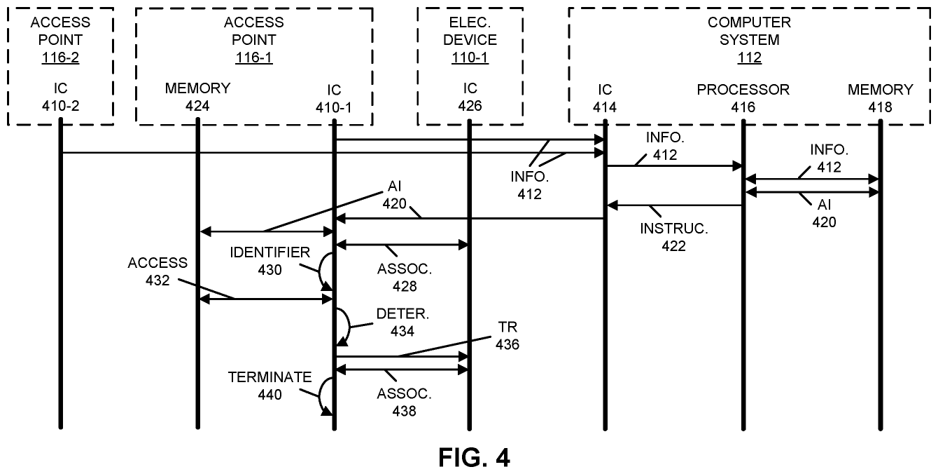

FIG. 4 presents a drawing illustrating an example of communication between electronic device 110-1, access points 116 and computer system 112. In FIG. 4, one or more interface circuits (ICs) 410 in access point 116 may provide, to computer system 112, information 412 associated with or that indicates historical band-of-frequency usage by electronic device 116-1. For example, a given access point may provide information 412 after associating with electronic device 110-1 in a band of frequencies.

After receiving information 412, an interface circuit 414 in computer system 112 may provide information 412 to processor 416 in computer system 112, which may store information 412 in memory 418 in computer system 112. Subsequently, processor 416 may access aggregated information (AI) 420 that indicates historical band-of-frequency usage by electronic device 116-1 in a wireless network, and may instruct 422 interface circuit 414 to provide aggregated information 420 to access points 116.

Moreover, after receiving aggregated information 420, interface circuit 410-1 in access point 116-1 may store aggregated information 420 in memory 424 in access point 116-1.

Then, an interface circuit 426 in electronic device 110-1 may associate 428 with an interface circuit 410-1 in a band of frequencies. Furthermore, interface circuit 410-1 access 432 aggregated information 422 in memory 424 based at least in part on an identifier 430 of or associated with electronic device 110-1 (such as a MAC address of electronic device 110-1) in order to determine 434 whether to provide, to electronic device 110-1, a transition recommendation (TR) 436 from the currently used band of frequencies to a second band of frequencies, which is different from the band of frequencies.

When interface circuit 410-1 determines that transition recommendation 436 should be provided (such as based at least in part on the historical band-of-frequency usage by electronic device 116-1), interface circuit 410-1 may provide transition recommendation 436 to electronic device 110-1. After receiving transition recommendation 436, interface circuit 426 may transition to the second band of frequencies, e.g., by associating 438 with interface circuit 410-1 in the second band of frequencies. For example, the band of frequencies may be associated with a WLAN hosted or provided by access point 116-1 and the second band of frequencies may be associated with a second or same WLAN hosted or provided by access point 116-1. Furthermore, after providing transition recommendation 436, interface circuit 410-1 may terminate 440 the association with interface circuit 426 in the band of frequencies.

While FIG. 4 illustrates some operations using unilateral or bilateral communication (which are, respectively, represented by one-sided and two-sided arrows), in general a given operation in FIG. 4 may involve unilateral or bilateral communication. Moreover, while FIG. 4 illustrates operations being performed sequentially or at different times, in other embodiments at least some of these operations may, at least in part, be performed concurrently or in parallel.

We now further describe the communication techniques. Notably, an access point may share capability data with a local or a cloud-based controller and management system for one or more clients that associate with or connect to a wireless network. For example, an access point serving a client may receive capability information, such as: one or more bands of frequencies the client supports; one or more supported IEEE 802.11 standards or communication protocols (such as IEEE 802.11be, IEEE 802.11ac, IEEE 802.11ax, IEEE 802.11n, etc.); an operating system; one or more types of applications executed by the client; airtime utilization, signal-to-noise ratio (SNR); and/or channel.

The local or a cloud-based controller and management system may have a configurable duration value for which the capabilities of the client are stored in the local or a cloud-based controller and management system. Moreover, the local or a cloud-based controller and management system may periodically and/or as-needed push the capability information to applicable access points in the wireless network. For example, the capability information may be selectively provided to access points based at least in part on: a network topology, neighbor access-point information, a floor plan in a building, etc.

Note that when the duration expires, the capabilities and other associated information about the client may be deleted by the local or a cloud-based controller and management system. In some embodiments, the duration may be user configured with minimum, maximum and/or default values. Alternatively, or additionally, in some embodiments, the duration may be calculated based at least in part on a total time that a client is connected, usage of the wireless network and/or a weighted metric based at least in part on a client profile. The client profile may be based at least in part on the use, by the client, of a variety of types of applications, such as Voice over Internet Protocol (VoIP), video, streaming, another use case, etc. The duration may be applicable to a given client and may be maintained by the local or a cloud-based controller and management system on a per-client basis.

As noted previously, the local or a cloud-based controller and management system may, on a regular basis, update client information and, as necessary, remove client information for client that are no longer serviced by the wireless network. Furthermore, on a periodic and/or as-needed basis, the local or a cloud-based controller and management system may share the updated data about clients to access points in the wireless network. In some embodiments, a given access point may receive the new data and may locally update the client information.

Additionally, as noted previously, some clients tend to remain in a channel in a lower band of frequencies. The disclosed communication techniques allow an access point to identify a client that is multi radio-band capable (e.g., based at least in part on past or historical band-usage behavior) and to request that the client switch to a higher band of frequencies, e.g., using IEEE 802.11v (such as using a BSS BTM frame or request). This capability may be useful, such as for a client that remains in a lower band of frequencies or a band of frequencies that is other than a preferred/expected one.

In some embodiments, a client may always want to connect to a higher band of frequencies, but because of heavy usage on the higher band of frequencies, the client may not get the required quality of experience (QoE) or adequate service. In these embodiments, the access point may ask the client to switch to a lower or a higher band of frequencies where the client can get adequate QoE. Moreover, in some embodiments, based at least in part on current conditions in a wireless network, the access point may allow the client to continue using the current band of frequencies without providing a transition recommendation.

Note that, based at least in part on the data from the local or cloud-based control and management system, the access point may have programmed intelligence to use information such as the client MAC address, hostname, username for 1× authentication, a radio band or band of frequencies (e.g., a 5 GHz band of frequencies or a 6 GHz band of frequencies), etc., to switch to transition to a higher band of frequencies in the access point and to keep legacy clients in a lower band of frequencies (or vice versa) based at least in part on current conditions in a wireless network.

For example, initially, the access points may: use a current band balancing or steering technique (such as when the client information is not available in the respective access-point data structure); and forward available data for clients to the local or cloud-based control and management system. Subsequently, as clients use the wireless network, and based at least in part on feedback from the local or cloud-based control and management system, the access points may move or transition the clients from their current bands of frequencies to bands of frequencies that are appropriate for current network conditions (such as to improve communication performance, e.g., throughput, and/or to provide equitable service to clients) and/or based at least in part on the historical band-of-frequency usage.

In some embodiments, during a first session, a client may provide a probe request in a 5 GHz band of frequencies to an access point, which responds to the client with a probe response. Then, the client may provide an authentication request to the access point, and the access point may provide an authentication response to the client. Next, the client may provide an association request to the access point. Afterwards, the access point may provide radio-band selection information to a computer system (such as the local or remote cloud-based computer system), including: the MAC address of the electronic device; band capabilities of the electronic device; usage of the electronic device; quality-of-service requirements of the electronic device; etc. The computer system may store this information in a data structure, which may include: the MAC address of the electronic device; the band capabilities of the electronic device; a duration for the electronic device; etc. Moreover, the access point may provide an association response to the client. Furthermore, the computer system may provide a radio-band selection update to the access point, including: the MAC address of the electronic device; a preferred band(s) of frequencies of the electronic device (such as a 2.4 GHz, a 5 GHz and/or a 6 GHz band of frequencies; the duration for the electronic device; etc.

Subsequent, during a second session, the client may associate with the access point in 2.4 GHz band of frequencies (e.g., by exchanging a probe request/response and an association request/response). Then, based at least in part on the radio-band selection information for the client, the access point may provide a transition recommendation to a different band of frequencies (such as a 5 GHz band of frequencies) to the client. Note that after the client has left the wireless network and the duration has expired, the access point may delete the radio-band selection information for the client.

Thus, the disclosed communication techniques may allow an access point to perform load balancing based at least in part on historical (such as one or more bands of frequencies used during one or more previous sessions) band-of-frequency usage by a particular client.

We now describe embodiments of an electronic device, which may perform at least some of the operations in the communication techniques. FIG. 5 presents a block diagram illustrating an example of an electronic device 500 in accordance with some embodiments, such as one of: base station 108, one of electronic devices 110, computer system 112, one of access points 116, one of radio nodes 118, switch 128 and/or AAA server 130. This electronic device includes processing subsystem 510, memory subsystem 512, and networking subsystem 514. Processing subsystem 510 includes one or more devices configured to perform computational operations. For example, processing subsystem 510 can include one or more microprocessors, ASICs, microcontrollers, programmable-logic devices, graphical processor units (GPUs) and/or one or more digital signal processors (DSPs).

Memory subsystem 512 includes one or more devices for storing data and/or instructions for processing subsystem 510 and networking subsystem 514. For example, memory subsystem 512 can include dynamic random access memory (DRAM), static random access memory (SRAM), and/or other types of memory (which collectively or individually are sometimes referred to as a ‘computer-readable storage medium’). In some embodiments, instructions for processing subsystem 510 in memory subsystem 512 include: one or more program modules or sets of instructions (such as program instructions 522 or operating system 524), which may be executed by processing subsystem 510. Note that the one or more computer programs may constitute a computer-program mechanism. Moreover, instructions in the various modules in memory subsystem 512 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 510.

In addition, memory subsystem 512 can include mechanisms for controlling access to the memory. In some embodiments, memory subsystem 512 includes a memory hierarchy that comprises one or more caches coupled to a memory in electronic device 500. In some of these embodiments, one or more of the caches is located in processing subsystem 510.

In some embodiments, memory subsystem 512 is coupled to one or more high-capacity mass-storage devices (not shown). For example, memory subsystem 512 can be coupled to a magnetic or optical drive, a solid-state drive, or another type of mass-storage device. In these embodiments, memory subsystem 512 can be used by electronic device 500 as fast-access storage for often-used data, while the mass-storage device is used to store less frequently used data.

Networking subsystem 514 includes one or more devices configured to couple to and communicate on a wired and/or wireless network (i.e., to perform network operations), including: control logic 516, an interface circuit 518 and one or more antennas 520 (or antenna elements). (While FIG. 5 includes one or more antennas 520, in some embodiments electronic device 500 includes one or more nodes, such as nodes 508, e.g., an antenna node, a connector or a pad, which can be coupled to the one or more antennas 520. Thus, electronic device 500 may or may not include the one or more antennas 520.) For example, networking subsystem 514 can include a Bluetooth networking system, a cellular networking system (e.g., a 3G/4G/5G network such as UMTS, LTE, SGNR, etc.), a USB networking system, a networking system based on the standards described in IEEE 802.11 (e.g., a Wi-Fi networking system), an Ethernet networking system, and/or another networking system.

In some embodiments, a transmit antenna radiation pattern of electronic device 500 may be adapted or changed using pattern shapers (such as reflectors) in one or more antennas 520 (or antenna elements), which can be independently and selectively electrically coupled to ground to steer the transmit antenna radiation pattern in different directions. Thus, if one or more antennas 520 includes N antenna-radiation-pattern shapers, the one or more antennas 520 may have 2^{N} different antenna-radiation-pattern configurations. More generally, a given antenna radiation pattern may include amplitudes and/or phases of signals that specify a direction of the main or primary lobe of the given antenna radiation pattern, as well as so-called ‘exclusion regions’ or ‘exclusion zones’ (which are sometimes referred to as ‘notches’ or ‘nulls’). Note that an exclusion zone of the given antenna radiation pattern includes a low-intensity region of the given antenna radiation pattern. While the intensity is not necessarily zero in the exclusion zone, it may be below a threshold, such as 3 dB or lower than the peak gain of the given antenna radiation pattern. Thus, the given antenna radiation pattern may include a local maximum (e.g., a primary beam) that directs gain in the direction of an electronic device that is of interest, and one or more local minima that reduce gain in the direction of other electronic devices that are not of interest. In this way, the given antenna radiation pattern may be selected so that communication that is undesirable (such as with the other electronic devices) is avoided to reduce or eliminate adverse effects, such as interference or crosstalk.

Networking subsystem 514 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 500 may use the mechanisms in networking subsystem 514 for performing simple wireless communication between the electronic devices, e.g., transmitting frames and/or scanning for frames transmitted by other electronic devices.

Within electronic device 500, processing subsystem 510, memory subsystem 512, and networking subsystem 514 are coupled together using bus 528. Bus 528 may include an electrical, optical, and/or electro-optical connection that the subsystems can use to communicate commands and data among one another. Although only one bus 528 is shown for clarity, different embodiments can include a different number or configuration of electrical, optical, and/or electro-optical connections among the subsystems.

In some embodiments, electronic device 500 includes a display subsystem 526 for displaying information on a display, which may include a display driver and the display, such as a liquid-crystal display, a multi-touch touchscreen, etc.

Electronic device 500 can be (or can be included in) any electronic device with at least one network interface. For example, electronic device 500 can be (or can be included in): a desktop computer, a laptop computer, a subnotebook/netbook, a server, a computer, a mainframe computer, a cloud-based computer, a tablet computer, a smartphone, a cellular telephone, a smartwatch, a wearable device, a consumer-electronic device, a portable computing device, an access point, a transceiver, a controller, a radio node, a router, a switch, communication equipment, a wireless dongle, test equipment, and/or another electronic device.

Although specific components are used to describe electronic device 500, in alternative embodiments, different components and/or subsystems may be present in electronic device 500. For example, electronic device 500 may include one or more additional processing subsystems, memory subsystems, networking subsystems, and/or display subsystems. Additionally, one or more of the subsystems may not be present in electronic device 500. Moreover, in some embodiments, electronic device 500 may include one or more additional subsystems that are not shown in FIG. 5. Also, although separate subsystems are shown in FIG. 5, in some embodiments some or all of a given subsystem or component can be integrated into one or more of the other subsystems or component(s) in electronic device 500. For example, in some embodiments program instructions 522 are included in operating system 524 and/or control logic 516 is included in interface circuit 518.

Moreover, the circuits and components in electronic device 500 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’ or a ‘means for communication’) may implement some or all of the functionality of networking subsystem 514. The integrated circuit may include hardware and/or software mechanisms that are used for transmitting wireless signals from electronic device 500 and receiving signals at electronic device 500 from other electronic devices. Aside from the mechanisms herein described, radios are generally known in the art and hence are not described in detail. In general, networking subsystem 514 and/or the integrated circuit can include any number of radios. Note that the radios in multiple-radio embodiments function in a similar way to the described single-radio embodiments.

In some embodiments, networking subsystem 514 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used Wi-Fi and/or Ethernet communication protocols as illustrative examples, in other embodiments a wide variety of communication protocols and, more generally, communication techniques may be used. Thus, the communication techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the communication techniques may be implemented using program instructions 522, operating system 524 (such as a driver for interface circuit 518) or in firmware in interface circuit 518. Alternatively, or additionally, at least some of the operations in the communication techniques may be implemented in a physical layer, such as hardware in interface circuit 518.

Additionally, while the preceding embodiments illustrated the use of wireless signals in one or more bands of frequencies, in other embodiments of these signals may be communicated in one or more bands of frequencies, including: a microwave frequency band, a radar frequency band, 900 MHz, 2.4 GHz, 5 GHz, 6 GHz, 7 GHz, 60 GHz, and/or a band of frequencies used by a Citizens Broadband Radio Service or by LTE. In some embodiments, the communication between electronic devices uses multi-user transmission (such as OFDMA).

In the preceding description, we refer to ‘some embodiments.’ Note that ‘some embodiments’ describes a subset of all of the possible embodiments, but does not always specify the same subset of embodiments. Moreover, note that numerical values in the preceding embodiments are illustrative examples of some embodiments. In other embodiments of the communication techniques, different numerical values may be used.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

1. An access point, comprising:
an interface circuit configured to wirelessly communicate with an electronic device, wherein the interface circuit is configured to:
associate with the electronic device in a band of frequencies;
access or obtain information associated with or that indicates historical band-of-frequency usage by the electronic device; and
based at least in part on the information, provide a transition recommendation addressed to the electronic device, wherein the transition recommendation recommends that the electronic device transition from the band of frequencies to a second band of frequencies, which is different from the band of frequencies.

2. The access point of claim 1, wherein the accessing or obtaining of the information is based at least in part on: a media access control (MAC) address of the electronic device; an identifier used during authentication of the electronic device; or a username or hostname of the electronic device.

3. The access point of claim 1, wherein the information is stored in memory in or associated with the access point.

4. The access point of claim 1, wherein the accessing or obtaining of the information comprises receiving, associated with a computer system, the information.

5. The access point of claim 4, wherein the computer system comprises: a controller of the access point; or a cloud-based computer system.

6. The access point of claim 1, wherein the information is associated with or indicates a type of application used by the electronic device; a capability of the electronic device; or a type of traffic associated with the electronic device.

7. The access point of claim 6, wherein the capability comprises an ability to operate in the second band of frequencies.

8. The access point of claim 1, wherein the band of frequencies comprises frequencies that are lower than frequencies in the second band of frequencies.

9. The access point of claim 1, wherein the transition recommendation comprises a basic service set (BSS) transition management (BTM) frame.

10. The access point of claim 1, wherein, after providing the transition recommendation, the access point is configured to terminate the association with the electronic device in the band of frequencies.

11. The access point of claim 1, wherein the band of frequencies is associated with a WLAN having a service set identifier (SSID) and a basic service set identifier (BSSID), and the second band of frequencies is associated with a second WLAN having a second SSID and a second BSSID.

12. A non-transitory computer-readable storage medium for use in conjunction with an access point, the computer-readable storage medium storing program instructions, wherein, when executed by the access point, the program instructions cause the access point to perform operations comprising:
associating with an electronic device in a band of frequencies;
accessing or obtaining information associated with or that indicates historical band-of-frequency usage by the electronic device; and
based at least in part on the information, provide a transition recommendation addressed to the electronic device, wherein the transition recommendation recommends that the electronic device transition from the band of frequencies to a second band of frequencies, which is different from the band of frequencies.

13. The non-transitory computer-readable storage medium of claim 12, wherein the accessing or obtaining of the information is based at least in part on: a media access control (MAC) address of the electronic device; an identifier used during authentication of the electronic device; or a username or hostname of the electronic device.

14. The non-transitory computer-readable storage medium of claim 12, wherein the accessing or obtaining of the information comprises receiving, associated with a computer system, the information; and
wherein the computer system comprises: a controller of the access point; or a cloud-based computer system.

15. The non-transitory computer-readable storage medium of claim 12, wherein the information is associated with or indicates a type of application used by the electronic device; a capability of the electronic device; or a type of traffic associated with the electronic device.

16. A method for providing a transition recommendation, comprising:
by an access point:
associating with an electronic device in a band of frequencies;
accessing or obtaining information associated with or that indicates historical band-of-frequency usage by the electronic device; and
based at least in part on the information, provide the transition recommendation addressed to the electronic device, wherein the transition recommendation recommends that the electronic device transition from the band of frequencies to a second band of frequencies, which is different from the band of frequencies.

17. The method of claim 16, wherein the accessing or obtaining of the information is based at least in part on: a media access control (MAC) address of the electronic device; an identifier used during authentication of the electronic device; or a username or hostname of the electronic device.

18. The method of claim 16, wherein the accessing or obtaining of the information comprises receiving, associated with a computer system, the information; and
wherein the computer system comprises: a controller of the access point; or a cloud-based computer system.

19. The method of claim 16, wherein the information is associated with or indicates a type of application used by the electronic device; a capability of the electronic device; or a type of traffic associated with the electronic device.

20. The method of claim 16, wherein the band of frequencies is associated with a WLAN having a service set identifier (SSID) and a basic service set identifier (BSSID), and the second band of frequencies is associated with a second WLAN having a second SSID and a second BSSID.
